(19) United States
(12) Patent Application Publication
(10) Pub. No.: US 2012/0141912 A1
(43) Pub. Date: Jun. 7, 2012

(54) FUEL CELL STACK COMPRISING AN IMPERMEABLE COATING

(75) Inventors: Kelly Ann O'Leary, Ionia, NY (US); Sean M. MacKinnon, Montreal (CA); Michael K. Budinski, Pittsford, NY (US); Timothy J. Fuller, Pittsford, NY (US); Mark A. Bissell, Pittsford, NY (US)

(73) Assignee: GM GLOBAL TECHNOLOGY OPERATIONS LLC, Detroit, MI (US)

(21) Appl. No.: 12/959,889

(22) Filed: Dec. 3, 2010

(51) Int. Cl. H01M 8/10; H01M 8/00

(52) U.S. Cl. 429/492; 429/535

(57) ABSTRACT

A fuel cell comprises a substantially contaminant free and contaminant impermeable coating disposed on at least one of a cathode, an anode, a gasket, an insulator plate, a cooler plate, a bipolar plate, a gas diffusion media layer, a polymer electrolyte membrane, an end plate, a tie-bolt, and a gas flow manifold. A process of producing a fuel cell and a fuel cell stack component are also disclosed.

### TECHNICAL FIELD

The field to which the disclosure generally relates includes fuel cells, fuel cell stack components and process of producing fuel cells.

### BACKGROUND

A fuel cell is a device capable of generating electricity from the electrochemical reactions of selected reactant gases. A unit fuel cell typically comprises an anode, a cathode, an electrolyte membrane, and a pair of gas flow distributors (such as bipolar plates) for directing reactant gases to the respective anode and cathode where the electrochemical reactions take place. Additional components, such as gaskets, gas diffusion layers, end plates, and cooler plate, are also included to further facilitate the fuel cell operation. During fuel cell operation, a fuel gas, such as hydrogen, is oxidized on the anode while an oxidant gas, such as oxygen, is reduced on the cathode. The electrochemical redox reactions on the anode and cathode are generally catalyzed by a metal catalyst, such as platinum. Electricity can be generated from such electrochemical reactions in a fuel cell at a high efficiency. The catalyst, however, is very sensitive to contaminants, such as ammonia, amines, sulfur compound, metal halides, carbon monoxide, phenols and many other organic and inorganic compounds. Components of a fuel cell must have very high chemical and physical stability because a fuel cell typically operates in a harsh environment of elevated temperatures, high relative humidity, strong oxidative and reductive atmosphere. Slight degradation of a fuel cell component due to hydrolysis, oxidation, reduction or leaching out of minor impurities may result in catalyst poisoning or impairment of electrolyte membrane function. Consequently, fuel cell components are usually made from limited numbers of high performance expensive materials. Materials containing inherent impurities or lack high chemical stability are generally avoided so far.

### SUMMARY OF EXEMPLARY EMBODIMENTS OF THE INVENTION

A fuel cell stack component comprises one of an anode, a cathode, a gasket, an insulator plate, a cooler plate, a bipolar plate, a gas diffusion media layer, a polymer electrolyte membrane, an end plate, a tie-bolt, and a gas flow manifold. The stack is surrounded by the balance of plant which included compressors, pumps, hoses, valves, manifolds, and other parts necessary to support the fuel cell stack. A substantially impermeable organic coating is disposed on the exterior surface of the stack component or balance of plant components.

One embodiment includes a fuel cell system comprising a substantially contaminant free and contaminant impermeable coating disposed on fuel cell components including, but not limited to, at least one of a cathode, an anode, a gasket, an insulator plate, a cooler plate, a bipolar plate, a gas diffusion media layer, a polymer electrolyte membrane, an end plate, a tie-bolt, gas flow manifold, compressors, pumps, hoses, valves, manifolds, or other surrounding parts supporting the fuel cell

A process of producing a fuel cell comprises: providing a fuel cell stack component; providing a solution comprising a contaminant free organic polymer resin dissolved in an organic solvent; and disposing or coating the solution on at least a part of the surface of the fuel cell component. A substantially impermeable coating or film is formed on the exterior surface of the stack or system component after evaporation of the organic solvent.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a perspective view of an un-assembled fuel cell stack.

FIG. 2 is a perspective view of another un-assembled fuel cell unit.

### DETAILED DESCRIPTION OF EXEMPLARY EMBODIMENTS

The following description of the embodiment(s) is merely exemplary in nature and is in no way intended to limit the invention, its application, or uses.

In one embodiment, the fuel cell comprises a plurality of fuel cell components stacked or otherwise assembled together to form a fuel cell stack. The fuel cell stack may include one or more units of electrochemical cells. Stacking of multiple units of electrochemical cells in the fuel cell stack multiplies the cell voltage and energy output of each unit cell. At least one of the fuel cell stack components comprises a substantially impermeable organic coating on at least part of its exterior surface. The coating at very small thickness is impermeable to metal halides, metal salts, phenols, sulfur compounds, amines, heavy hydrocarbons, and the like, under normal fuel cell operating conditions. The coating comprises an organic polymer resin substantially free of any leachable metal or organic contaminants. The coating is durable and exhibits several characteristics when disposed on a fuel cell component, as described below in more details.

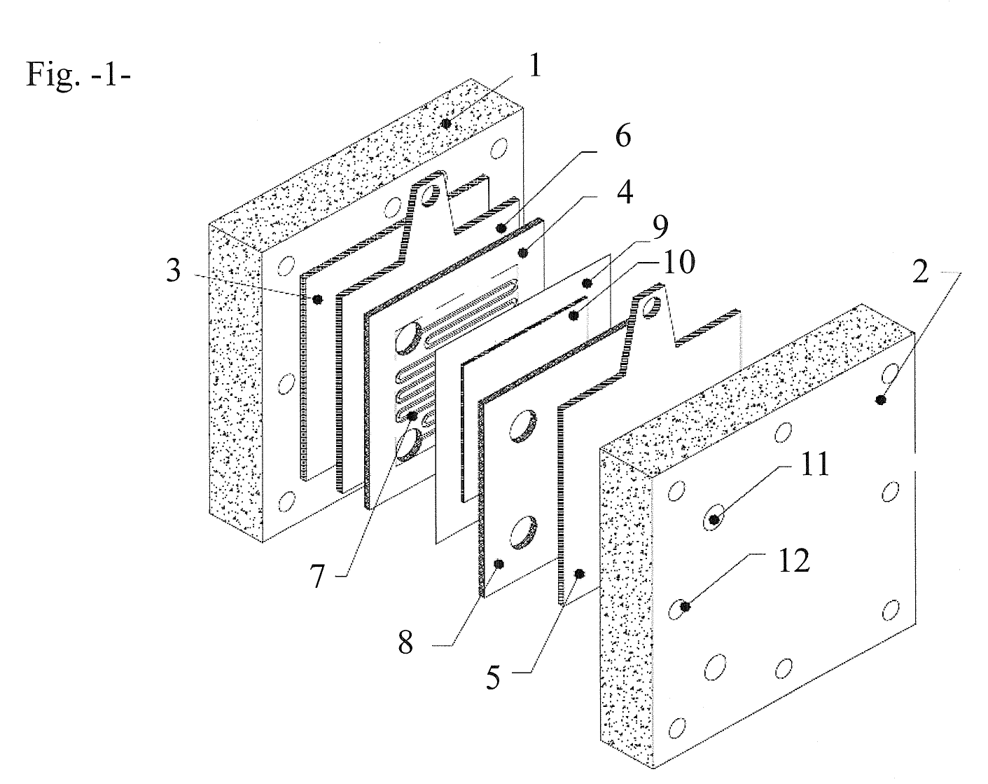

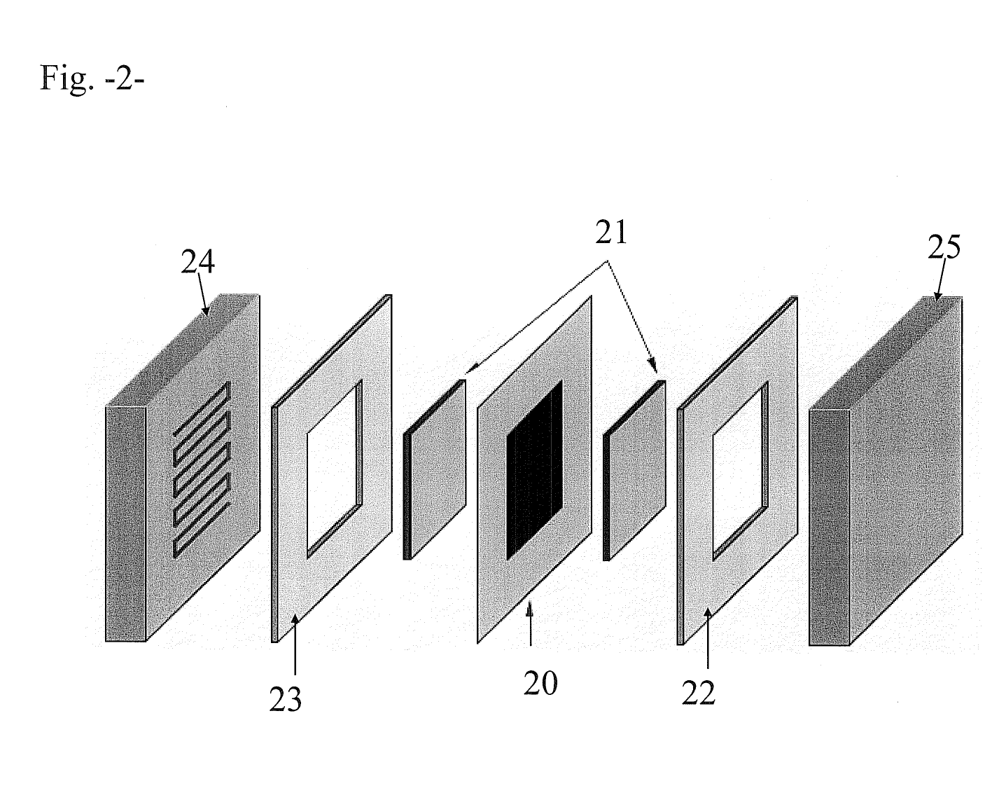

Various fuel cell stack components or fuel cell system parts may be coated with the impermeable organic coating or film. Typically fuel cell stack components may include, but not limited to, anode, cathode, electrolyte membrane, gas diffusion media layer, bipolar plate, gas flow distributor layer, cooler plate, end plate, insulator plate, gasket, current collector plate, tie-bolts, sealants, gas flow manifold, humidifier, pumps, compressors, hoses, valves, and manifolds. FIG. 1 is a perspective view of an exemplary unassembled single unit fuel cell, showing several of the fuel cell stack components and how they may be assembled together to form a fuel cell unit. This exemplary fuel cell comprises a polymer electrolyte membrane (PEM) 9, sandwiched between an anode (not visible in the view) and a cathode 10. The anode and cathode each comprises a catalyst that is capable of catalyzing the corresponding electrochemical half-cell reactions on the electrodes. A gas diffusion media layer (not shown) may optionally be disposed on each of the anode and the cathode to facilitate reactant gas supply to the entire electrodes. The PEM, anode and cathode may be pre-assembled into one integrated stack component, herein referred to as a membrane electrode assembly (MEA). Two gas flow distributor layers or bipolar plates, 4 and 8, are each disposed on the anode and cathode side as shown in FIG. 1. The gas flow distributor layer or bipolar plate usually includes gas flow channels 7 to direct continuous reactant gas flow over the active areas of the anode and cathode. Current collectors 6 and 5 are provided to collect electricity produced by the fuel cell and to connect to external electricity-consuming devices. In other configurations, current collector and bipolar plates may be combined into a single plate. The fuel cell shown in FIG. 1 also includes at least one insulator plate 3 and end plates 1 and 2. The insulator plate prevents current leakage and the end plates provide mechanical fixture for clamping the stack component together. The end plate may include an array of openings, such as numeral 12 for inserting a tie-bolt and 11 for connecting reactant gas inlet/outlet manifolds. FIG. 2 is a perspective view of another un-assembled fuel cell unit. The fuel cell unit includes a MEA 20, two gas diffusion media layers 21, disposed on both sides of the MEA, two gaskets 22 and 23, and two bipolar plates 24 and 25. Optionally, a microporous layer (not shown in FIG. 2) may be disposed between the gas diffusion layer and the corresponding electrode layer on the MEA. The gaskets 22 and 23 provide proper spacing control between the electrode and the corresponding bipolar plate. The fuel cell unit shown in FIG. 2 may be repeated multiple times to form a larger fuel cell stack for a higher cell voltage and energy output capacity.

In one embodiment, the microporous layer may be made from materials such as carbon blacks and hydrophobic constituents such as polytetrafluoroethylene (PTFE) and polyvinylidene fluoride (PVDF), and may have a thickness ranging from about 2 to about 100 micrometers. The microporous layer may include, for example, a plurality of particles including graphitized carbon, and a binder. The binder may include a hydrophobic polymer such as, but not limited to, polyvinylidene fluoride (PVdF), fluoroethylene propylene polymer (FEP), polytetrafluoroethylene (PTFE), or other organic or inorganic hydrophobic materials. The particles and binder may be included in a liquid phase comprising, for example, a mixture of an organic solvent and water to provide dispersion. In various embodiments, the solvent may include at least one of 2-propanol, 1-propanol, ethanol, propylene glycol, glycol ether, glycol ester, etc. The dispersion may be applied to a fuel cell stack component, such as a gas diffusion media layer as a hydrophobic coating layer. In another embodiment, the dispersion may be applied to an electrode. The dispersion may be dried (by evaporating the solvent) and the resulting dried microporous layer may include 60-90 weight percent particles and 10-40 weight percent binder. In various other embodiments, the binder may range from 10-30 weight percent of the dried microporous layer.

The gas diffusion media layer may include any electrically conductive porous material. In various embodiments, the gas diffusion media layer may include non-woven carbon fiber paper, knit or woven carbon cloth which may be treated with a hydrophobic material, such as, but not limited to, polymers of polyvinylidene fluoride (PVDF), fluroethylene propylene, or polytetrafluoroethylene (PTFE). The gas diffusion media layer may have an average pore size ranging from 5-40 micrometers. The gas diffusion media layer may have a thickness ranging from about 100 to about 500 micrometers.

The electrodes (cathode layer and anode layer) may comprise catalyst layers which may include catalyst particles such as platinum, and an ion conductive material such as a proton conducting ionomer, intermingled with the particles. The proton conductive material may be an ionomer such as a perfluorinated sulfonic acid polymer. The catalyst materials may include metals such as platinum, palladium, and mixtures of metals such as platinum and molybdenum, platinum and cobalt, platinum and ruthenium, platinum and nickel, platinum and tin, other platinum transition-metal alloys, and other fuel cell electrocatalysts known in the art. The catalyst materials may be finely divided if desired to provide high reactive surface area. The catalyst materials may be unsupported or supported on a variety of materials such as but not limited to finely divided carbon particles. Inorganic oxides and organic support materials such as polynuclear aromatic hydrocarbons and heterocyclic aromatic compounds may be used as the support or electrode material. One example of the organic support material is C.I. (Color Index) PIGMENT RED 149 (perylene red or PR 149, available from American Hoechst Corp. of Somerset, N.J.).

A variety of different types of membranes may be used in embodiments of the invention. The solid polymer electrolyte membrane useful in various embodiments of the invention may be an ion-conductive material. Examples of suitable membranes are disclosed in U.S. Pat. Nos. 4,272,353 and 3,134,689, and in the Journal of Power Sources, Volume 28 (1990), pages 367-387. Such membranes are also known as ion exchange resin membranes. The resins include ionic groups in their polymeric structure; one ionic component for which is fixed or retained by the polymeric matrix and at least one other ionic component being a mobile replaceable ion electrostatically associated with the fixed component. The ability of the mobile ion to be replaced under appropriate conditions with other ions imparts ion exchange characteristics to these materials.

The ion exchange resins can be prepared by polymerizing a mixture of ingredients, one of which contains an ionic constituent. One broad class of cationic exchange, proton conductive resins is the so-called sulfonic acid cationic exchange resin. In the sulfonic acid membranes, the cationic exchange groups are sulfonic acid groups which are attached to the polymer backbone.

The formation of these ion exchange resins into membranes or chutes is well-known to those skilled in the art. The preferred type is perfluorinated sulfonic acid polymer electrolyte in which the entire membrane structure has ionic exchange characteristics. These membranes are commercially available, and a typical example of a commercial sulfonic perfluorocarbon proton conductive membrane is sold by E. I. DuPont D Nemours & Company under the trade designation NAFION®. Other such membranes are available from Asahi Glass and Asahi Chemical Company. The use of other types of membranes, such as, but not limited to, perfluorinated cation-exchange membranes, hydrocarbon based cation-exchange membranes as well as anion-exchange membranes are also within the scope of the invention.

The bipolar plates may include one or more layers of a metal, a graphite, and/or an electrically conductive composite material. The bipolar plate typically includes at least a pattern of gas flow channels for directing reactant gas to the electrode. Various gas flow patterns may be used, including, but not limited to, serpentine, interdigitated, and mesh-like flow fields. In one embodiment, the bipolar plates include stainless steel with or without a surface treatment for enhanced contact conductivity and/or corrosion resistance. Various patterns of lands and channels may be formed in the bipolar plate by machining, etching, stamping, molding or the like. The lands and channels may define a reactant gas flow field to deliver a fuel on one side of the bipolar plate and an oxidant on the other side of the plate.

At least one of the fuel cell stack components or surrounding components is coated with a substantially impermeable organic film. The coating may comprise an organic polymer resin. The polymer resin generally has good chemical and mechanical stabilities. In one embodiment, the resin comprises an addition polymer that does not contain a hydrolysable condensation group such as ester, amide, imide, urethane, and anhydride. The resin may comprise, for example, a homopolymer or copolymer of vinylidene fluoride. Copolymer of vinylidene fluoride may be prepared by polymerizing vinylidene fluoride with at least one of methyl methacrylate, tetrafluoroethylene, chlorotrifluoroethylene, hexafluoropropylene, vinyl fluoride, styrene, ethylene, propylene, isoprene, butadiene, and acrylonitrile. Examples of vinylidene fluoride copolymers include, but not limited to, poly(vinylidene fluoride-co-tetrafluoroethylene), poly(vinylidene fluoride-co-hexafluoropropylene), poly(vinylidene fluoride-co-tetrafluoroethylene-co-hexafluoropropylene), poly(vinylidene fluoride-co-ethylene), poly(vinylidene fluoride-co-chlorotrifluoroethylene), and poly(vinylidene fluoride-co-methyl methacrylate). Homopolymer of vinylidene fluoride and a few copolymers of vinylidene fluoride are commercially available from Arkema, Inc., Philadelphia, Pa., under the trade designation KYNAR®. The polymer resin may have a tensile strength between about 10 MPa (mega Pascal) and 100 MPa, or about 14 MPa and 60 MPa measured according to ASTM D 638 “Standard Test Method for Tensile Properties of Plastics”. The elongation at break of the polymer resin is generally in the range of about 10% to about 600%, or 50% to about 500%. Dielectric strength of the polymer resin is preferably in the range of 0.5 to 1.8, 0.8 to 1.6, or 1.1 to 1.7 measured according to ASTM D 149 at 73° F. (23° C.). The dielectric constant of the resin is preferably in the range of 3.0 to 14, 3.2 to 12, or 4.5 to 9.5 measured according to ASTM D 150 at a frequency between 100 MHz and 100 Hz. Furthermore, the resin generally has very low water absorption, allowing the resin coating to withstand the high relative humidity in an operating fuel cell, and to provide an impermeable barrier to contaminants. Typical water absorption of the coating resin measured after immersion in water at 20° C. for 24 hours is less than 0.01%, 0.02%, 0.04% or 0.06% by weight. The polymer resin does not contain significant amount of leachable impurities that may contaminate the fuel cell catalyst or membrane electrolyte. The resin is synthesized and prepared to avoid residue metal catalyst or processing aids. No heat stabilizers (such as phenol antioxidants), lubricating additives, or sulfur containing organic compounds are present in the polymer resin. In particular, no single metal element heavier than calcium is detectable at greater than 1 ppb or 0.2 ppb after the resin is immersed in deionized water at 80° C. for 24 hours. The polymer resin is substantially free of Pb, Hg, Cd, Sn, Zn, H₂Se, H₂Te, and AsH₃. In other words, the polymer resin used to prepare the organic coating is substantially contaminant free.

In one embodiment, the polymer resin is a thermoplastic resin and is soluble in an organic solvent. Various organic solvents may be used as long as the resin is soluble in the solvent, and a continuous impermeable coating can be formed from the solution. Examples of organic solvents may include, but not limited to, tetrahydrofuran, methyl ethyl ketone, N,N-dimethyl formamide, N,N-dimethyl acetamide, dimethyl sulfoxide, trimethylphosphate, N-methyl-2-pyrrolidone and any mixtures thereof. A solution containing about 1% to 50% or 5% to 30% polymer resin by weight may be used to form a coating on a fuel cell stack component. The polymer resin solution may be applied to a part of or the entire exterior surface of a fuel cell stack component to form a thin and substantially impermeable film. The solution may be applied to a stack component by dip coating, spray coating, brushing, painting, transfer coating, electrostatic spraying, spin coating, and any other coating methods known in the field. The solvent may be dried at room temperature or at an elevated temperature to evaporate the solvent at a controlled rate to allow the formation of a continuous impermeable film. Typically drying temperature ranges from about 40° C. to about 180° C. Different drying temperatures may be used at different stages of drying for the formation of a impermeable coating film. A low temperature, between about 40° C. and 80° C. may be used at initial drying stage to remove part of the organic solvent without causing excessive skin formation and blistering. At later stage of drying, the drying temperature may be raised to about 120° C. or above to accelerate the removal of residue solvent, to improve coating adhesion and to assist the formation of a continuous film. The resulting coating thickness for an impermeable coating layer is typically in the range of 0.1 micrometer to about 100 micrometers, 0.5 micrometer to about 10 micrometers, or 1 micrometer to 10 micrometers.

In one embodiment, a fuel cell component comprising a material that would not meet the stringent requirements of a fuel cell is coated with the polymer resin to form a thin and impermeable coating on its exterior surface. The coated stack component exhibits suitable properties for use in a fuel cell. In another embodiment, a stack component prone to chemical attacks by redox chemical species, acid, base, or fluorides generated from the polymer electrolyte membrane may be protected by the impermeable coating. The impermeable coating can also prevent undesirable migration of contaminants from one location to another in the fuel cell. The coating thus enables the use of a wider variety of materials to construct a fuel cell component at a lower cost. For example, an anode insulator plate comprising a commercially available grade of PPA such as, but not limited to, Solvay's Amodel® AS1933) less chemically stable material is painted with an N,N-dimethyl acetamide solution of a vinylidene fluoride polymer (KYNAR available from Arkema, Inc., and dried at about 50 C for 24 hours However, the dry may be conducted at a range of 40-150 C for various time periods. When tested in a fuel cell, the anode insulator plate exhibits acceptable durability and no significant amount of contaminants are leached out to cause significant adverse effect on the performance of the fuel cell. Similarly, a gasket, made from plastics or rubbers, generally contains leachable antioxidants, curing agent, metal catalysts, residue monomers, sulfur accelerators, and amine stabilizers. Those additives, even at very low level, can cause significant damage to the fuel cell catalyst and/or the electrolyte membrane. After having a thin and impermeable coating layer of the polymer film on its exterior surface, the gasket material may be used in a fuel cell with an acceptably low level, if any, of leachable contaminants. Fuel cell cooler plates, gas flow manifolds, end plates, tie-bolts, nuts, and other components mentioned above may be coated with the polymer resin as well.

The above description of embodiments of the invention is merely exemplary in nature and, thus, variations thereof are not to be regarded as a departure from the spirit and scope of the invention.

1. A fuel cell system component comprising at least one of an anode, a cathode, a gasket, an insulator plate, a cooler plate, a bipolar plate, a gas diffusion media layer, a polymer electrolyte membrane, an end plate, a tie-bolt, a gas flow manifold, pump, compressor, valve, hose, or manifolds wherein a substantially impermeable organic coating is disposed on the exterior surface of said component, wherein said organic coating is formed from a solution of a polymer resin dissolved in an organic solvent.

2. A fuel cell system component as set forth in claim 1, wherein said organic coating comprises a copolymer or a homopolymer of vinylidene fluoride.

3. (canceled)

4. A fuel cell system component as set forth in claim 1, wherein said polymer resin is a homopolymer or a copolymer of vinylidene fluoride, and said organic solvent comprises tetrahydrofuran, methyl ethyl ketone, N,N-dimethyl formamide, N,N-dimethyl acetamide, dimethyl sulfoxide, trimethylphosphate, N-methyl-2-pyrrolidone or any mixtures thereof.

5. A fuel cell system component as set forth in claim 1, wherein said organic coating has a detectable single metal (heavier than calcium) content at 1 ppb or less after immersed in de-ionized water at 80° C. for 24 hours.

6. A fuel cell system component as set forth in claim 1, wherein said coating has a thickness between about 0.1 micrometer and about 100 micrometers.

7. A fuel cell system component as set forth in claim 1, wherein said coating has a tensile strength between 10 and 100 MPa, an elongation at break between about 10% to about 500%, and a dielectric strength between 0.8 and 1.7 at 23° C.

8. A fuel cell system component as set forth in claim 1 is an insulator plate, a gas flow manifold, an end plate or a gasket.

9. A fuel cell comprising a substantially contaminant free and contaminant impermeable coating disposed on at least one of a cathode, an anode, a gasket, an insulator plate, a cooler plate, a bipolar plate, a gas diffusion media layer, a polymer electrolyte membrane, an end plate, a tie-bolt, or a gas flow manifold, wherein said coating is formed from a polymer resin solution in an organic solvent, and said coating is a substantially continuous film.

10. A fuel cell as set forth in claim 9, wherein said coating comprises an organic resin having no more than 1 ppb leachable single metal element heavier than calcium in water, and a water absorption of less than about 0.1% by weight.

11. A fuel cell as set forth in claim 9, wherein said coating is substantially impermeable to metal halides, heavy hydrocarbons, phenols, and sulfur compounds.

12. A fuel cell as set forth in claim 9, wherein said coating has a thickness between about 0.1 micrometer and 100 micrometers.

13. A fuel cell as set forth in claim 9, wherein said coating comprises a thermoplastic resin soluble in an organic solvent.

14. (canceled)

15. A fuel cell as set forth in claim 9, wherein said solvent comprises tetrahydrofuran, methyl ethyl ketone, N,N-dimethyl formamide, N,N-dimethyl acetamide, dimethyl sulfoxide, trimethylphosphate, N-methyl-2-pyrrolidone or any mixtures thereof.

16. A fuel cell as set forth in claim 15, wherein said coating comprises a polymer selected from the group consisting of poly(vinylidene fluoride), poly(vinylidene fluoride-co-tetrafluoroethylene), poly(vinylidene fluoride-co-tetrafluoroethylene-co-hexafluoropropylene), poly(vinylidene fluoride-co-hexafluoropropylene, poly(vinylidene fluoride-co-ethylene), poly(vinylidene fluoride-co-chlorotrifluoroethylene), and poly(vinylidene fluoride-co-methyl methacrylate).

17. A fuel cell as set forth in claim 15, wherein said coating is disposed on at least one of an insulator plate, a gasket, an end plate, and a gas flow manifold.

18. A process of producing a fuel cell comprising: providing a fuel cell stack component; providing a solution comprising a contaminant free organic polymer resin dissolved in an organic solvent; and disposing or coating said solution on at least a part of the surface of said stack component such that a substantially impermeable coating or film is formed after evaporation of said solvent.

19. A process as set forth in claim 18, wherein said organic polymer resin is a homopolymer or a copolymer of vinylidene fluoride, and said organic solvent comprises tetrahydrofuran, methyl ethyl ketone, N,N-dimethyl formamide, N,N-dimethyl acetamide, dimethyl sulfoxide, trimethylphosphate, N-methyl-2-pyrrolidone or any mixtures thereof.

20. A process as set forth in claim 19, wherein said fuel cell stack component is at least one of an insulator plate, an end plate, a gasket and a gas flow manifold.

21. A fuel cell system component comprising a substantially impermeable organic coating is disposed on the exterior surface of said component, the organic coating comprising a copolymer or a homopolymer of vinylidene fluoride.

22. A fuel cell system component comprising at least one of an insulator plate, a cooler plate, an end plate, a tie-bolt, a gas flow manifold, a pump, a compressor, a valve, a hose or a manifold wherein a substantially impermeable organic coating is disposed on the exterior surface of said component.

23. A fuel cell system component comprising an insulator plate and a substantially impermeable organic coating is disposed on the insulator plate.

24. A fuel cell system component comprising a gasket and a substantially impermeable organic coating is disposed on the gasket.

25. A fuel cell component as set forth in claim 24 wherein the gasket comprises a leachable material comprising at least one of leachable antioxidants, curing agent, metal catalysts, residue monomers, sulfur accelerators, or amine stabilizers, and wherein the substantially impermeable organic coating is constructed and arranged to prevent the leachable material from leaching from the gasket.
